(19) United States
(12) Patent Application Publication
(10) Pub. No.: US 2008/0315564 A1
(43) Pub. Date: Dec. 25, 2008

(54) Airbag Assembly, Gear and Operating Method for Said Assembly

(76) Inventor: Helmut Muller, Russelsheim (DE)

Correspondence Address: Fleit Gibbons Gutman Bongini & Bianco PL, 21355 EAST DIXIE HIGHWAY, SUITE 115, MIAMI, FL, 33180, US

(21) Appl. No.: 10/599,426

(22) PCT Filed: Feb. 22, 2005
(86) PCT No.: PCT/DE05/00297

§ 371 Date: Nov. 19, 2007

(30) Foreign Application Priority Data
Mar. 31, 2004 (DE) 20 2004 005 036.6

(51) Int. Cl. B60R 21/16

(52) U.S. Cl. 280/728.2

(57) ABSTRACT

The invention relates to an airbag assembly comprising a mechanism for a stationary driver's airbag, i.e. an airbag that does not rotate with the rotation of the steering wheel. Said airbag assembly is configured in such a way that the mechanism is situated inside the steering column. The invention also relates to a gear and an operating method for an airbag assembly of this type.

### FIELD OF THE INVENTION

The invention pertains to an airbag assembly, a gear and all operating method for said assembly. The invention specifically pertains to a non-rotating driver's airbag in a steering wheel of an automobile.

### BACKGROUND OF THE INVENTION

Nowadays, driver's airbags in practice rotate with the steering wheel. This has two disadvantages. First, the airbag needs to be “round” because the position of the steering wheel during an accident is unpredictable. In addition, the power supply of the actual airbag device usually needs to be realized with an expensive so-called “volute spring.” The latter also applies to the connection of switches for “multifunctional steering wheels” customarily installed in modern automobiles. This topic is already the object of additional developments, for example, as described in publications by the firms Autoliv, TRW, Faurecia, ZF and Takata, among others.

A non-rotating airbag is already disclosed in Offenlegungsschrift DE 21 31 902 of Jun. 26, 1971. In this case, the “sun gear” of a “planet gear” mounted in the steering wheel is fixed in the upper end of the steering gear shaft. Alternatively, the power is transmitted between the gearwheel on the end of the steering gear shaft and the “sun gear” in the steering wheel by means of three “planet gears.” The disadvantage of such constructions is the weight of the gear in the steering wheel that is particularly unsuitable for automobiles with diesel engines due to disagreeable vibrations. Other disadvantages can be seen in that the steering gear shaft rotates with a speed that is two-times to three-times faster and in that the rotating direction of the steering gear shaft is reversed. Completely new steering gears on the front axle and different leverages are required in this case.

In addition, DE 21 31 902 discloses the state of the art for “stationary” cable leadthroughs for the operation of switches. In this case, the steering shaft is divided as well as offset and connected by means of gearwheels.

Furthermore, German patent 872011 of Jul. 8, 1949 discloses a non-rotating clock in a steering wheel that is realized by means of planet gears.

### SUMMARY OF THE INVENTION

The present invention is based on the objective of improving the existing technology and has attained this objective.

In the context of the present invention, the steering column is essentially divided, in particular, into an upper and a lower half. A zone suitable for the stationary connection of a “non-rotating” airbag including its cable leadthrough is preferably situated in the region between the steering column halves.

The upper part and the lower part of the steering wheel shaft are connected with various types of gears in alternative embodiments. The gear is preferably situated in the region of the connection of the steering column and therefore does not lead to an increased vibration tendency of the steering mechanism.

In other alternative embodiments, the steering wheel has the same rotating direction and rotational speed as the “lower” steering shaft. New steering gears are not required in this case.

Consequently, the invention discloses an alternative gear, particularly with respect to the state of the art, for stationary positioning of a driver's airbag in an automobile independently of the steering angle of the steering wheel. This makes it possible to utilize airbags with a superior and encompassing shape that also cover the A-column. The cable lead-throughs of the airbag and the multifunctional steering wheel can be simply realized in a stationary fashion.

Solutions optimized with respect to costs, structural space and functions are illustrated in the figures in the form of corresponding embodiments and described below. In this respect, individual characteristics and combinations of characteristics may also be combined within the scope of professional expertise, and the respective combinations of characteristics defining individual embodiments do not restrict the invention to such combinations only.

The incorporation of a servo mechanism and, if so required, a dynamic change in the angle of rotation between the steering wheel and the steering shaft can be realized.

Special design options and advantages of the present invention and its embodiments are:
improved protective effect of the airbag due to its specific shape.
simple cable lead-throughs for the airbag and the multifunctional steering wheel.
solid connection of the airbag support tube on/to a stationary element in/on the steering column tube.
alternatives with identical or opposite rotating directions of steering wheel and steering shaft.
alternatives with identical or different rotational speeds of steering wheel and steering shaft.
space-saving construction, usually within the steering column tube.
alternative mechanisms with cylindrical gearwheels, angular gearwheels or a chain (see, e.g., FIG. 16).
a “highlight” in the form of a parallel planet gear set within the steering column tube, namely without influencing the rotating direction or the rotating speed (see, e.g., FIG. 6).
only one planet gear set required in the stationary housing of the steering column tube if the steering gear is adapted accordingly (see, e.g., FIG. 7).
alternatives with a bevel gear for identical rotational speed of steering wheel and shaft, alternatively with opposite or identical rotating direction (see, e.g., FIGS. 10 and 11).
simple incorporation of a servo mechanism, namely either constant or dynamically dependent on the angle of rotation and the speed (see, e.g., FIGS. 13 and 14).
another “highlight” in the form of a gear and an airbag with static cable leadthrough rigidly connected to the steering column tube. The steering wheel with integrated sun gear drives planet gears on a shaft. The drive is realized in the form of a planet gear that meshes with a sun gear forming the end piece of the steering shaft. This is realized within the flange of the steering wheel or within the stationary steering column tube, respectively (see, e.g., FIGS. 18 and 19).

### BRIEF DESCRIPTION OF THE DRAWINGS

The invention is merely elucidated in an exemplary fashion with reference to the embodiments and application examples in accordance with the present invention, that are illustrated in the figures and described below, in which:

FIGS. 1a, 1b, and 1c show an embodiment with a steering wheel;

FIGS. 2a, 2b, and 2c show section A of FIGS. 1a, 1b and 1c;

FIGS. 3a, 3b, and 3c show an intermediate gear;

FIGS. 4a, 4b and 4c show a differently designed steering gear;

FIGS. 5a, 5b and 5c show an alternate form of a differently designed steering gear;

FIGS. 6a, 6b, and 6c show another embodiment, in which the airbag rests on a molded tube;

FIGS. 7a, 7b, and 7c, show another embodiment, in which the lower sun gear and the lower planet gear are eliminated;

FIGS. 8a, 8b, and 8c show the arrangement of the sun gears and the planet gears;

FIGS. 9a, 9b, and 9c show section C of FIGS. 6a, 6b, and 6c;

FIGS. 10a, 10b, and 10c show an alternative to the technology that is illustrated in FIGS. 7a, 7b, and 7c;

FIGS. 11a, 11b, and 11c, show a gearwheel and axle added to the embodiment according to FIGS. 10a, 10b, and 10c;

FIGS. 12a, 12b, and 12c show another embodiment in the form of an alternative with a laterally attached transmission;

FIGS. 13a, 1t3b, and 13c, show a variation of FIGS. 12a, 12b, and 12c, including a servo mechanism/power steering system;

FIGS. 14a, 14b, and 14c, show a device for changing the transmission;

FIGS. 15a, 15b, and 15c show means for horn actuation;

FIGS. 16a, b, c show an alternative in which the mechanism is divided into a short steering column shaft and a long steering column shaft;

FIGS. 17a, b, c show section D of FIGS. 16a, 16b and 16c;

FIGS. 18a, 18b, and 18c show another embodiment in which all outer stationary steering column tube carries the stationary airbag;

FIGS. 19a, 19b, and 19c show section E of FIGS. 18a, 18b and 18c;

FIGS. 20a, 20b, and 20c show an alternative embodiment according to FIGS. 19a, 19b, and 19c, in which four sets of gearwheels are used.

### DETAILED DESCRIPTION OF THE INVENTION

Preferred and/or advantageous embodiments of the invention result from the claims and their combinations as well as the entire present application documents.

Embodiments of the invention are described in greater detail below with reference to the figures.

The invention is merely elucidated in an exemplary fashion with reference to the embodiments and application examples that are illustrated in the figures and described below. Process and device characteristics also respectively result analogously from device and process descriptions.

In the individual figures and illustrations, identical or similar components or components with identical or similar functions are identified by the same reference symbols. The illustrations in the figures also reveal characteristics that are not provided with reference symbols, namely irrespective of the fact whether or not such characteristics are described below. On the other hand, characteristics that are mentioned in the present description but that are not visible or illustrated in the figures are self-explanatory for a person skilled in the art.

Individual characteristics that are cited and/or illustrated in connection with specific embodiments are not restricted to these embodiments or the combination with the remaining characteristics of these embodiments, but may also be combined with any other variations within the bounds of technical possibility, namely even if they are not discussed separately in the present documents.

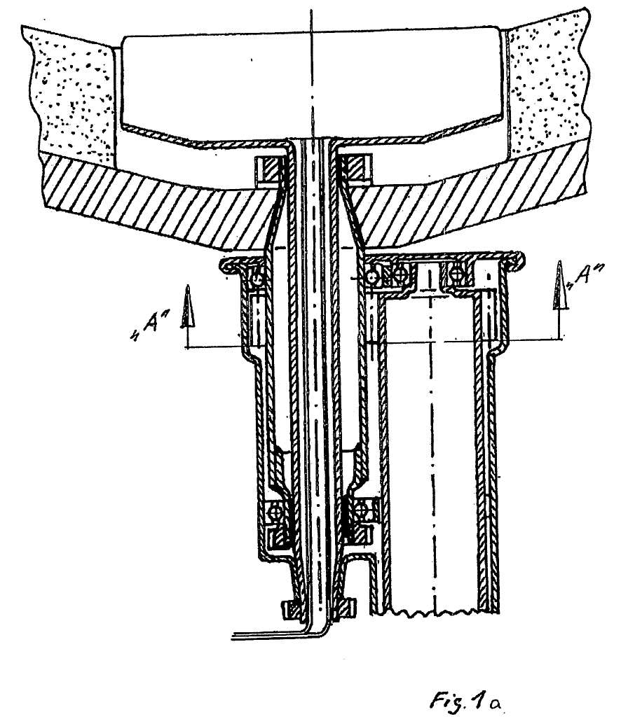

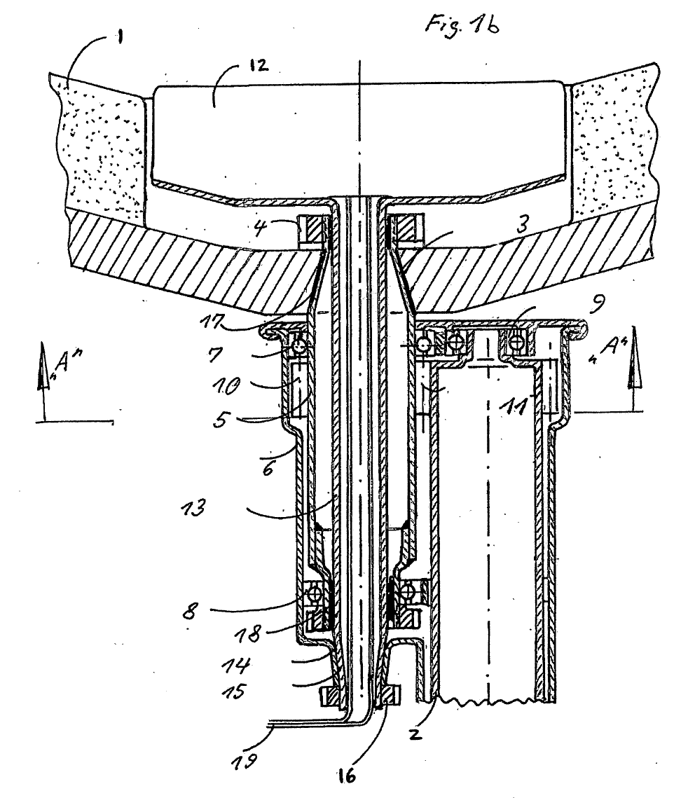

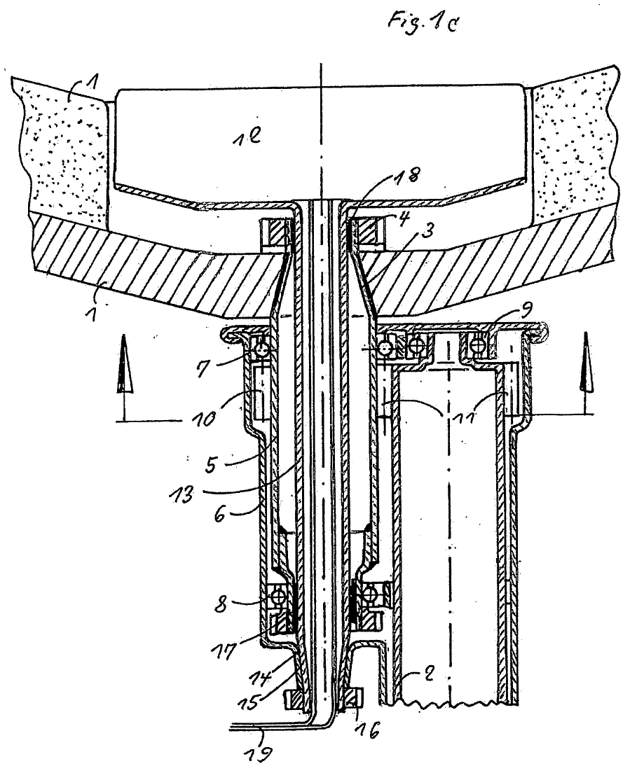

FIGS. 1a, b, c show a first embodiment with a steering wheel 1 that is not conventionally mounted on the steering column shaft 2 by means of a cone 3 and a nut 4, but rather on a second hollow shaft 5 arranged laterally parallel thereto. Analogous to the actual steering column shaft 2, this hollow shaft 5 is also supported in a steering column housing 6. FIGS. 1a, b, c show the two bearings 7 and 8 of the hollow shaft and the upper bearing 9 of the actual steering column shaft 2.

Both shafts, namely the steering column shaft 2 and the hollow shaft 5, are provided with gear rims 10 and 11 that precisely “mesh” without play. If the transmission is 1:1, the steering column shaft 2 rotates exactly as fast as the hollow shaft 5. This represents the normal case. Other transmissions can be realized.

The embodiment according to FIGS. 1a, b, c does not show the option of changing the transmission in accordance with today's conventional technical standard. This requires engaging and disengaging meshing gears on each of the shafts 2 and 5. During parking maneuvers at slow speeds, this would result in indirect steering, i.e., in a smoothly operating steering mechanism. At higher speeds, this would result in a direct and more stable transmission. Other shifting stages can be realized. However, this is not discussed in greater detail because variable speed transmissions with shafts form part of the state of the art and can be correspondingly integrated into the invention or combined therewith by any person skilled in the art. The shifting pulse then preferably results from the scanned speed of the vehicle.

A continuous variation of the transmission can also be achieved with an automatic transmission that may be realized in accordance with any customary technical design.

After the steering wheel 1 is installed on the hollow shaft 5, an airbag 12 provided with another hollow shaft 13 is inserted into the hollow shaft 5. A secure and stationarily positioned mounting is provided on the end of the hollow shaft 13 of the airbag 12. In the embodiment shown, this consists of a cone 14 with not-shown slot-and-key positioning. This configuration is secured by drawing the cone 14 or the hollow shaft 13 into a cone 15 of the steering housing 6 by means of a nut 16. Other customary technical mounting options may be considered and fall under the scope of the present invention.

The airbag 12 is now stationarily mounted on its hollow shaft 13 in the steering column housing 6. The hollow shaft 5 rotates about this hollow shaft 13 on the bearings 7 and 8. The steering wheel 1 is mounted on this hollow shaft 5. If so required, slide bushings 17 and 18 may be alternately installed in order to avoid friction between the two hollow shafts 5 and 13.

Another advantage of this “stationary” airbag 12 can be seen in that all cables 19 can extend through its hollow shaft 13. This applies analogously and particularly to the cables of a (not-shown) multifunctional steering wheel. In this case, its switches are non-rotatably or similarly mounted on the (not-shown) airbag housing.

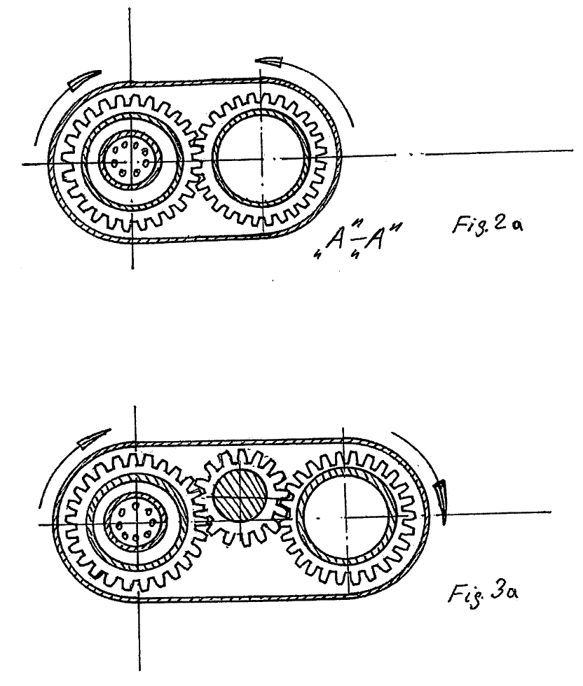

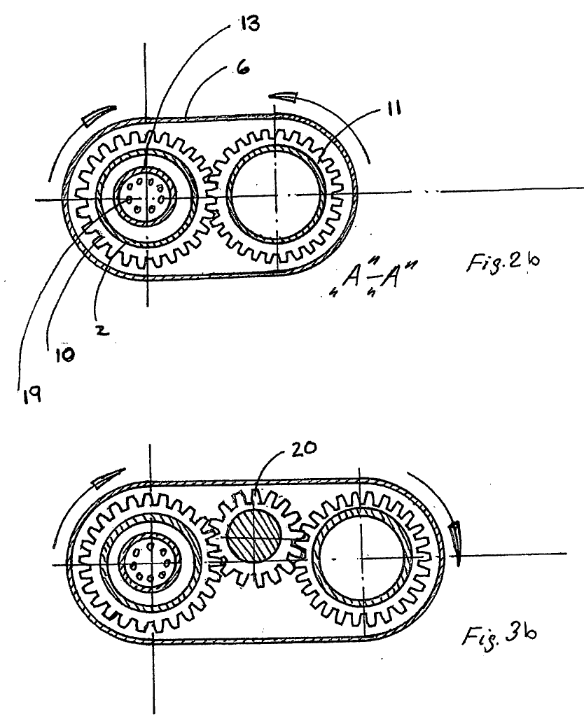

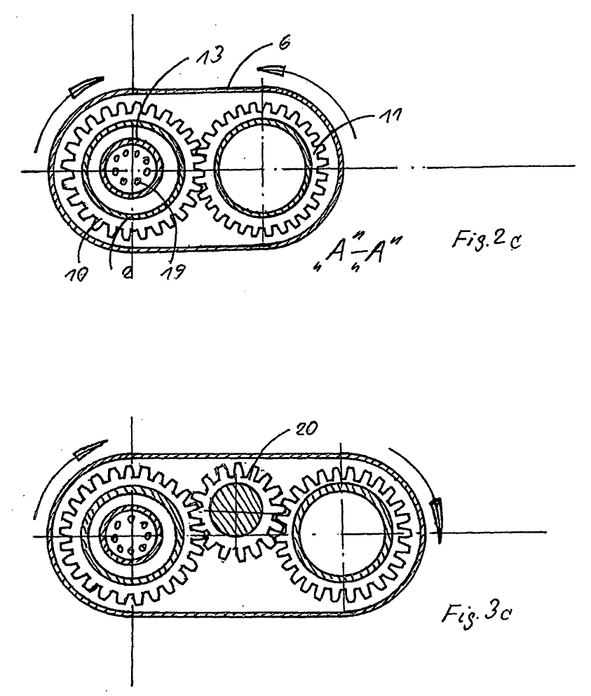

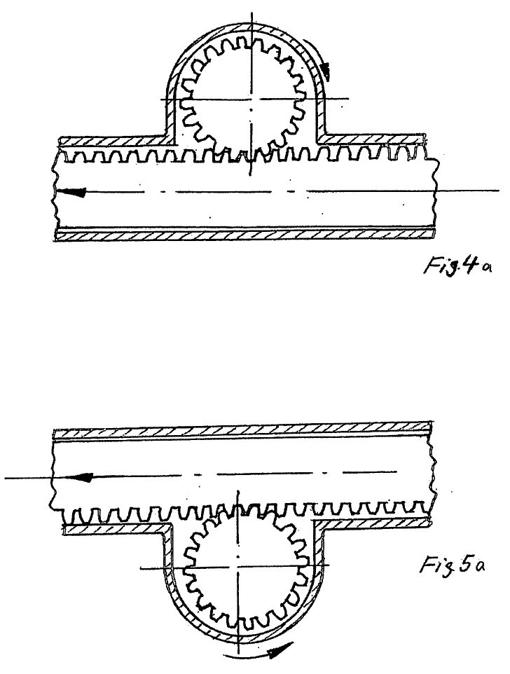

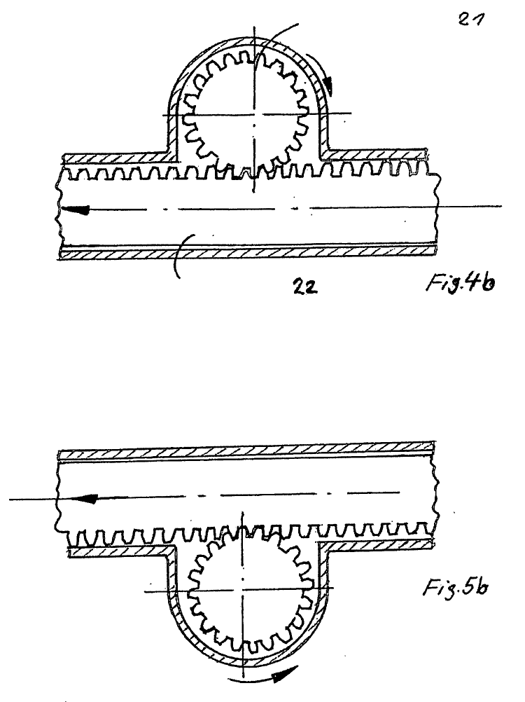

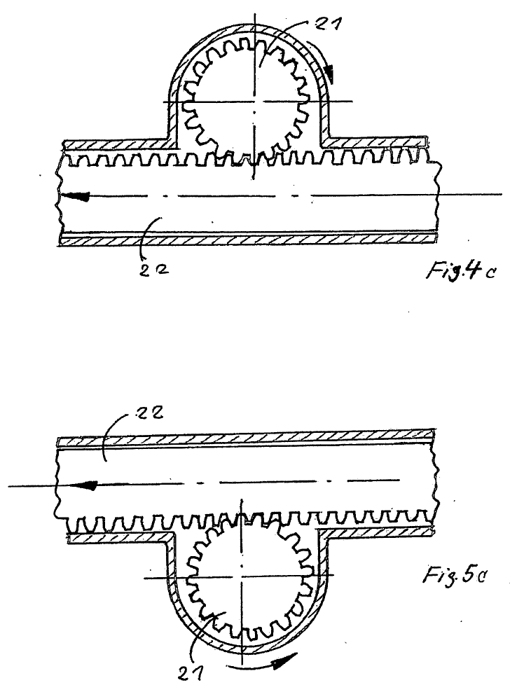

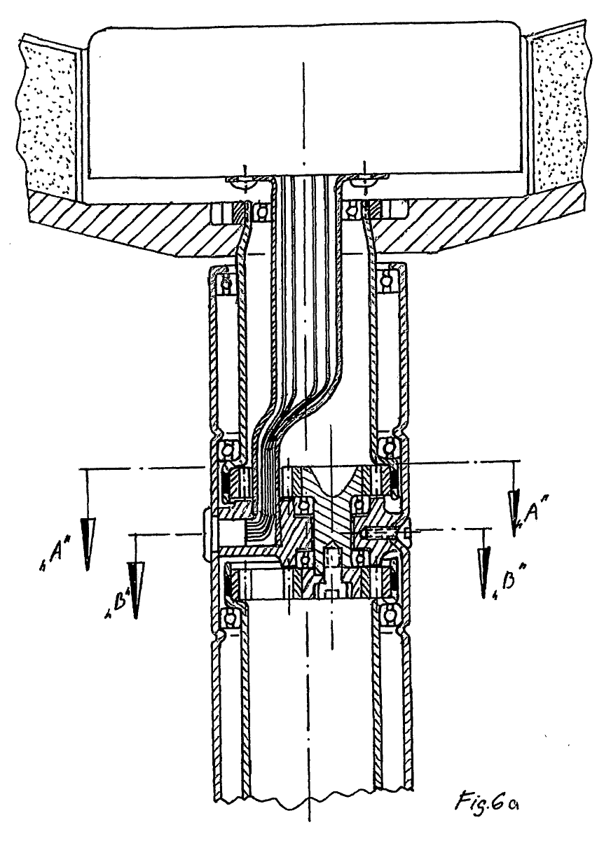

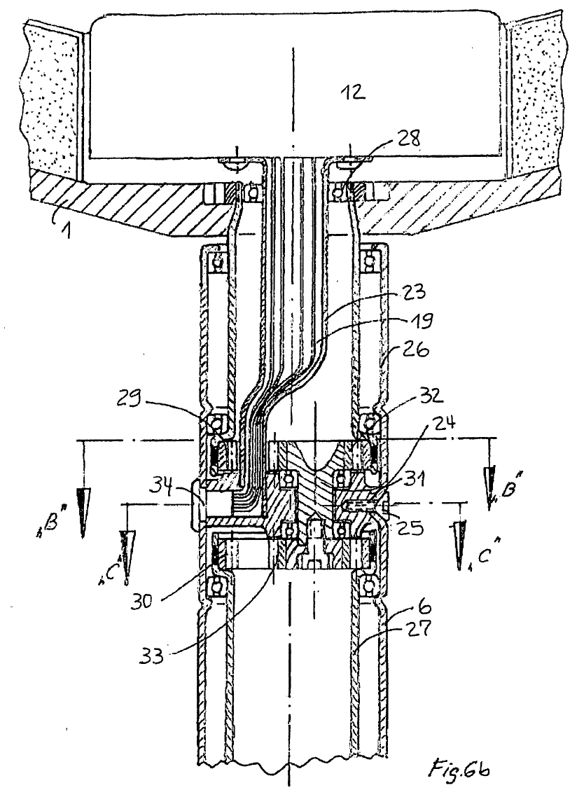

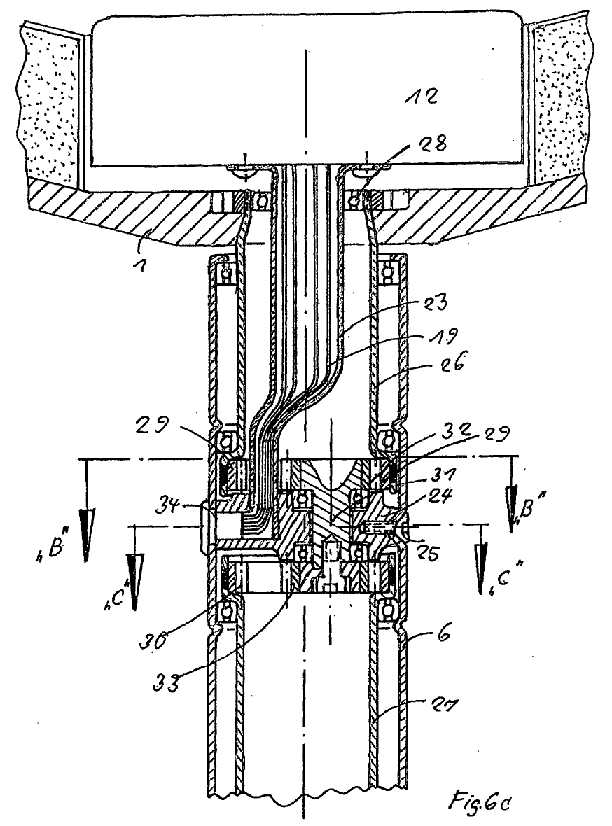

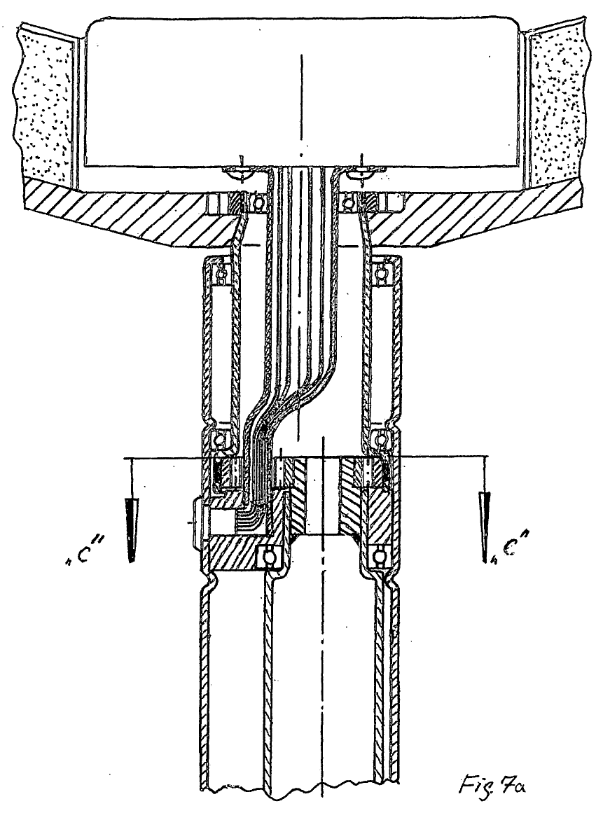

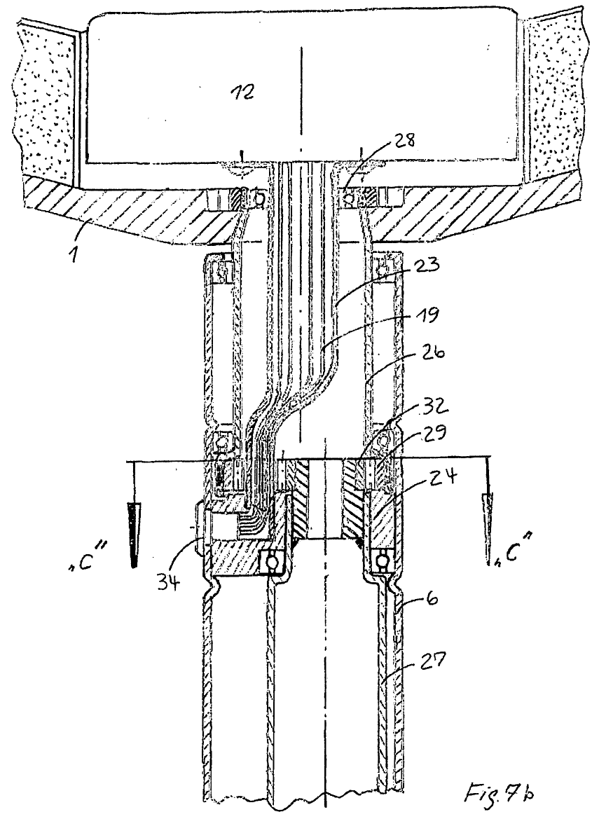

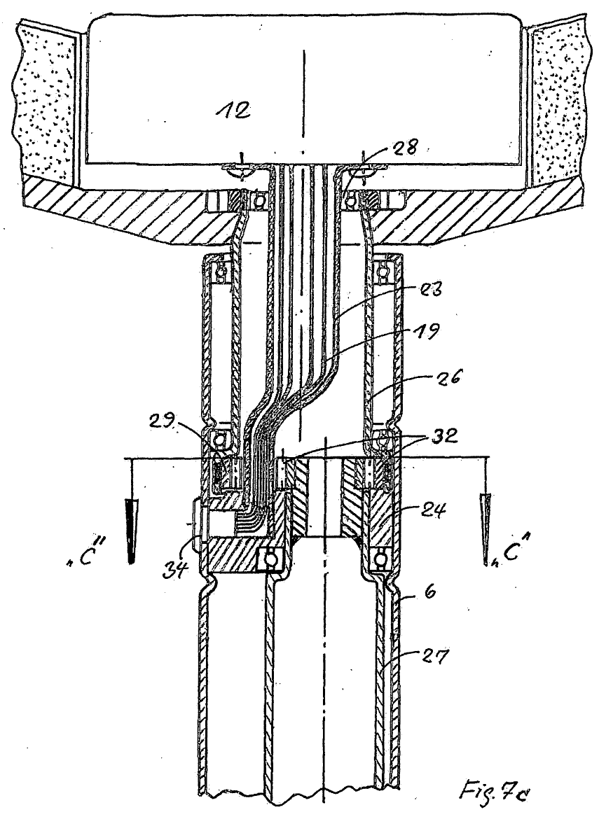

In the embodiment shown in FIGS. 1a, b, c, the steering wheel 1 turns in the opposite direction of the steering column shaft 2 (see also FIGS. 2a, b, c). This means that, for example, a lower pinion gear 21 needs to “mesh” with the opposite side of a rack 22 in the steering gear housing (see also FIGS. 5a, b, c) or the steering arms need to extend rearward in a mirror-inverted fashion if they extend forward prior thereto and vice versa (see also FIGS. 4a, b, c).

If an existing steering gear and an existing steering mechanism should be used, an intermediate gear 20 is preferably arranged between the gear rim 10 of the hollow shaft 5 and a gear rim 11 of the steering column shaft 2 (see also FIGS. 3a, b, c).

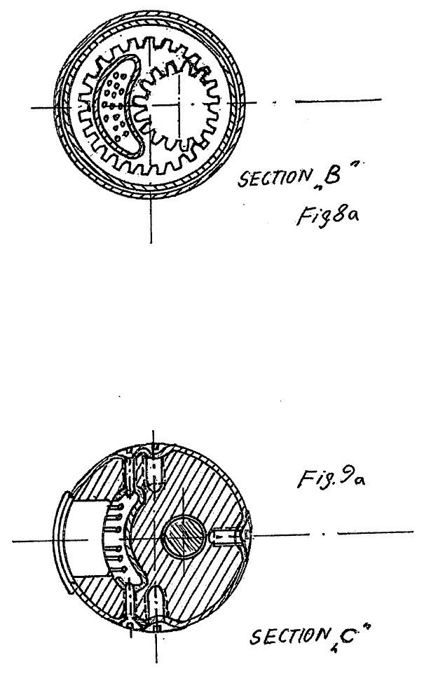

FIGS. 6a, b, c show another embodiment, in which the airbag 12 rests on a molded tube 23 that also serves for leading through the cables 19. The cables 19 of (not-shown) “multifunctional steering wheels” also extend through this tube. The tube 23 is supported in an upper steering column shaft 26 by means of a bearing 28. The molded tube 23 rests on a molded bearing part 24 that is fixed in the steering column housing 6 with screws 25 or the like. The upper (26) and the lower steering column shaft 27 are respectively supported separately in the steering column housing 6 underneath and above the molded bearing part 24. “Sun gears” 29 and 30 are mounted in the upper (26) and the lower steering column shaft 27, namely on their respective ends. An axle 31 is inserted into and supported in the molded bearing part 24. The ends of the axle 31 are provided with planet gears 32, 33. The planet gears 32, 33 mesh with the sun gears 29, 30 and transmit the rotational movement of the upper steering column shaft to the lower steering column shaft 27. The advantage of this assembly is the possible 1:1 rotary motion between the bottom shaft section and the top shaft section and the preservation of the rotating direction. In addition, this embodiment represents a very compact gear that can be arranged within the steering column housing without requiring additional space.

In another embodiment that is shown in FIGS. 7a, b, c, the lower sun gear 30 and the lower planet gear 33 are eliminated. The axle 31 of the upper planet gear 32 is rigidly connected to the lower steering column shaft 27. It is eccentrically supported in the molded bearing part 24. In this case, the advantage can be seen in the eliminated gears 30, 33; the disadvantages are the reversed rotating direction of the lower steering column shaft 27 relative to the upper steering column shaft 26 and a forced speed increasing transmission of approximately 1:2. A differently designed steering gear is required on the front axle (see, e.g., FIGS. 4a, b, c and 5a, b, c, wherein the number of teeth of the lower pinion gear 21 would have to be reduced in FIGS. 5a, b, c in accordance with the transmission).

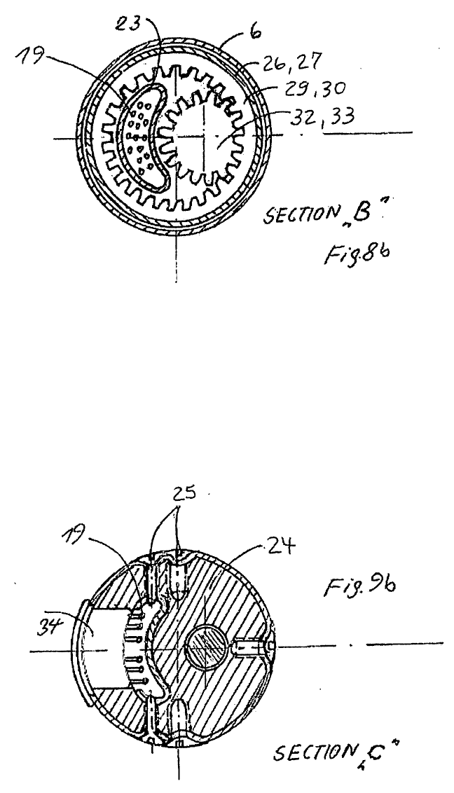

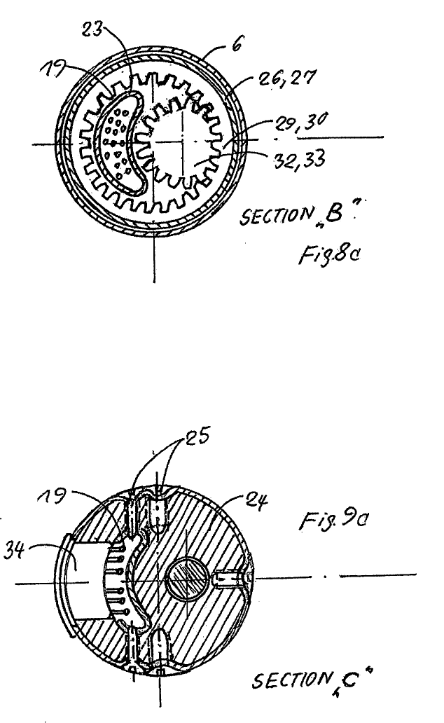

FIGS. 8a, b, c show the arrangement of the sun gears 29, 30 and the planet gears 32, 33 in the form of section B of FIGS. 6a, b, c and 7a, b, c. The molded tube 23 lies in the free region between the gears.

FIGS. 9a, b, c show section C of FIGS. 6a, b, c. Screws 25 are used for fixing the molded bearing part 24 and the molded tube 23. This figure also shows the plug connector 34 for the cables 19 that is held by the assembly of the molded tube 23 and the molded bearing part 24.

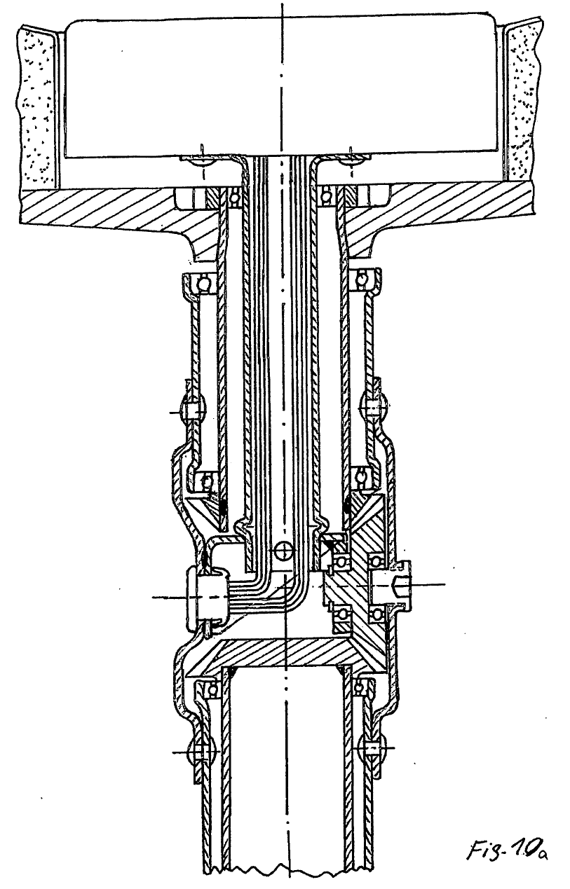

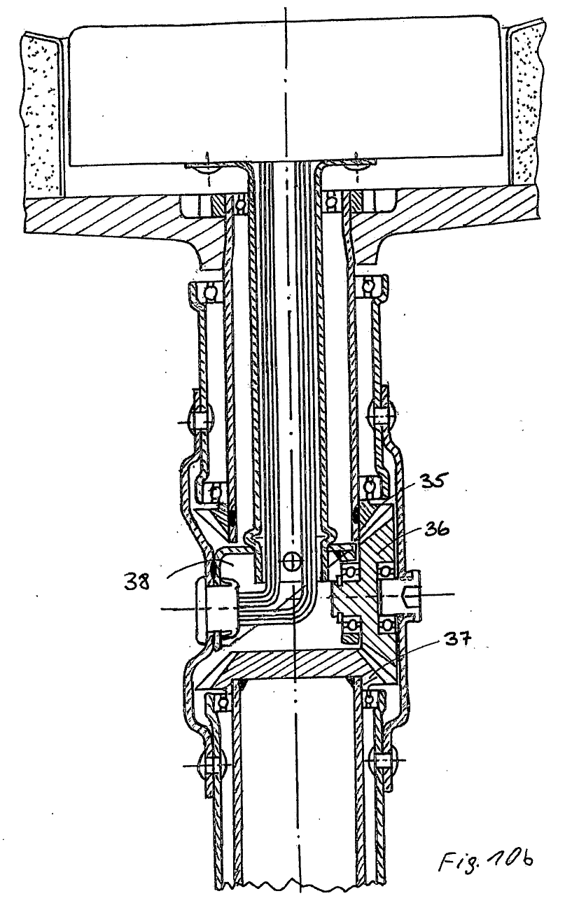

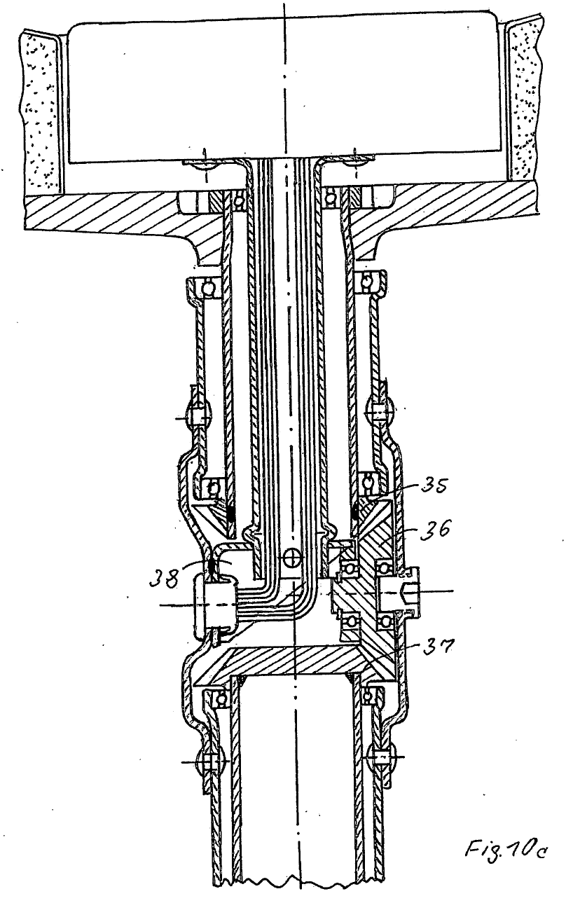

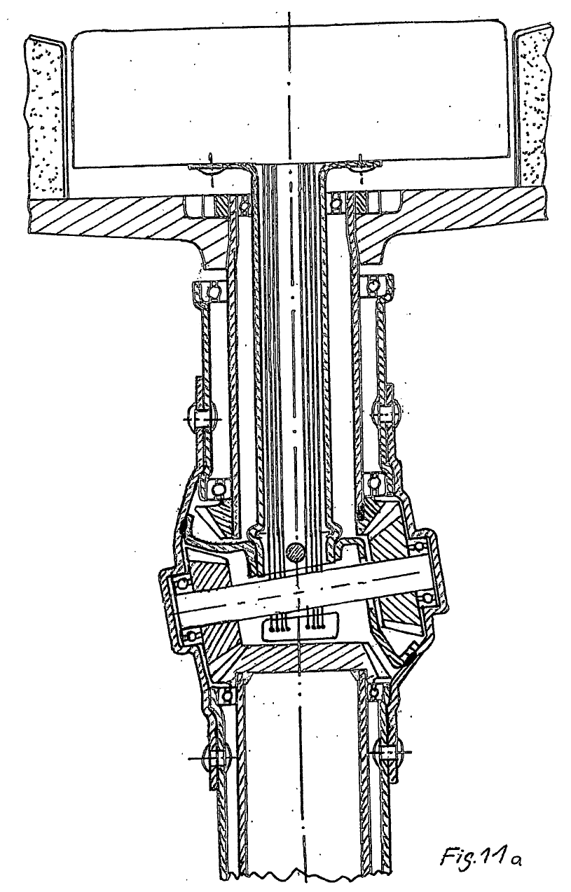

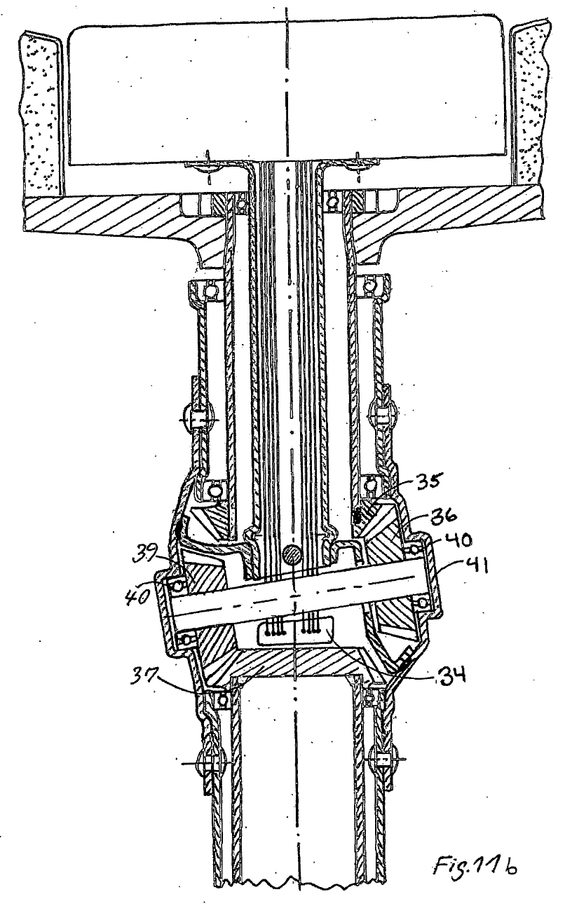

FIGS. 10a, b, c show an alternative to the technology that is illustrated in FIGS. 7a, b, c and described with reference thereto, namely in the form of an additional embodiment with helical gearwheels 35, 36, 37. The molded bearing part 24 is replaced with a welded sheet metal construction 38. The advantage of this assembly is that the upper and the lower steering column shafts 26, 27 can have the same rotational speed. However, the shafts rotate in opposite directions.

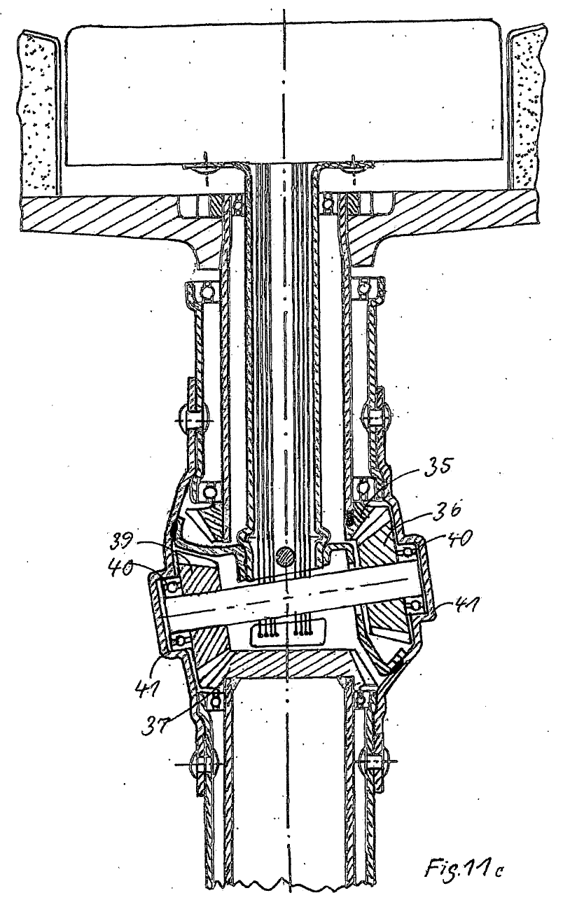

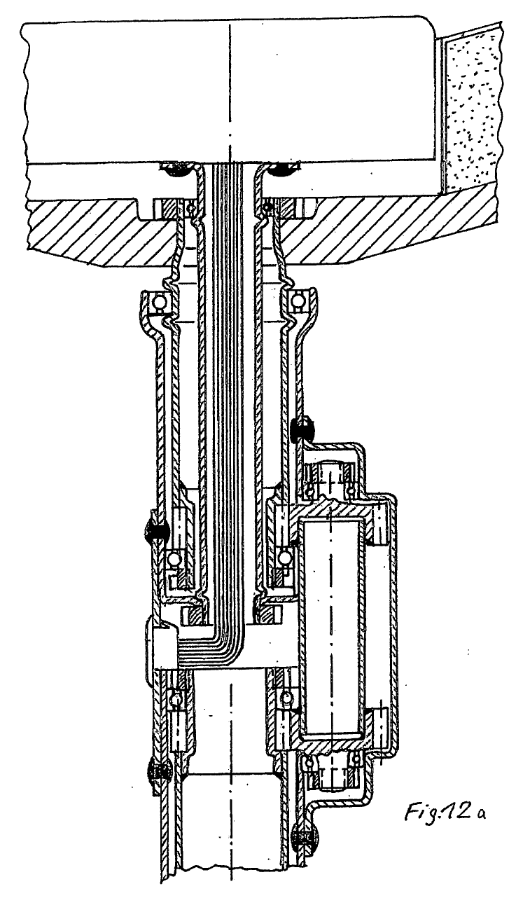

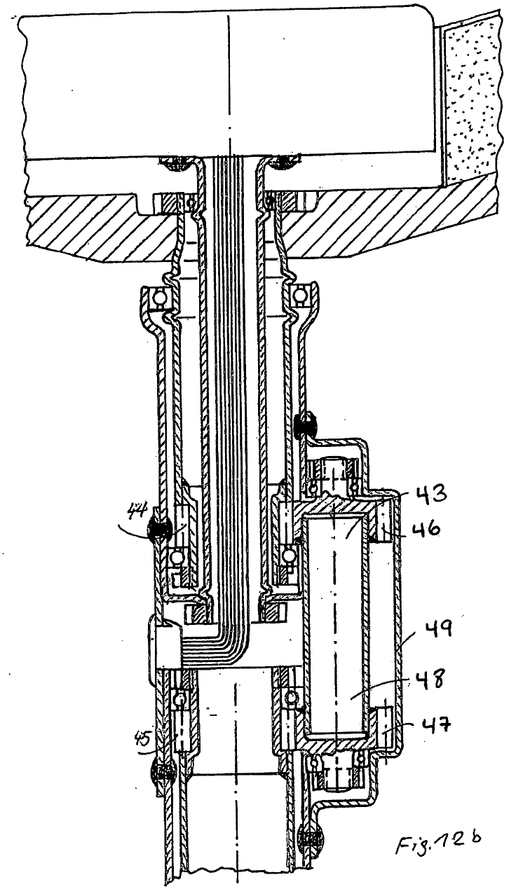

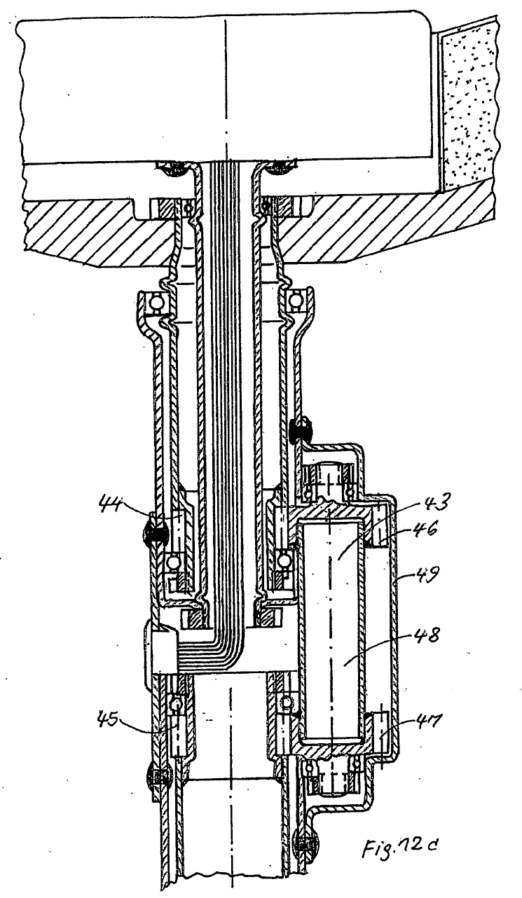

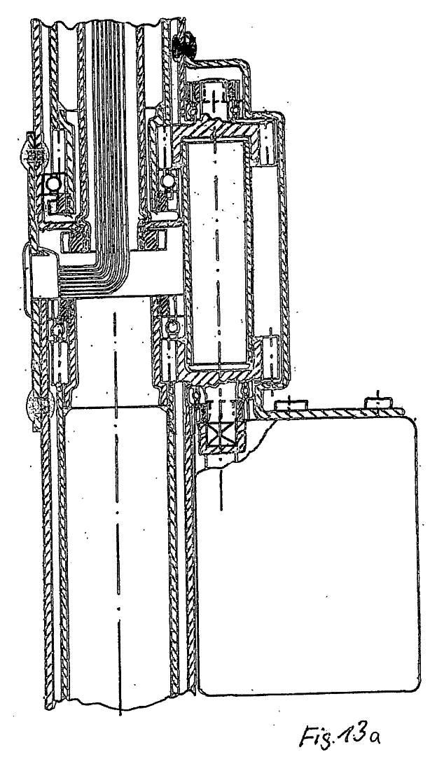

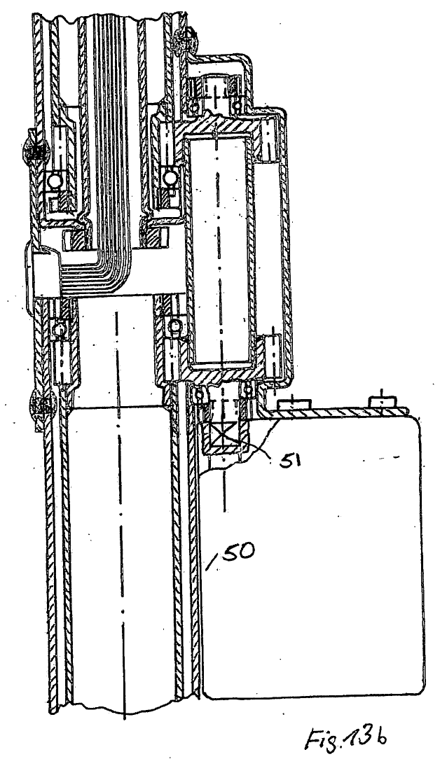

In another embodiment that is illustrated in FIGS. 11a, b, c, another gearwheel 39 and its axle 42 are added to the embodiment according to FIGS. 10a, b, c in order to realize the same rotating direction of both steering column shafts 26, 27. An appropriate stamped sheet metal housing 41 is provided for the support 40.

FIGS. 12a, b, c show another embodiment in the form of an alternative with a laterally attached transmission 43. Two gearwheels 44, 45 mounted on the upper and the lower steering column shaft 26, 27 “mesh” with both gearwheels 46, 47 on the gear axle. All components are installed in a housing 49 as shown in the figures. This represents a simple solution if sufficient space is available.

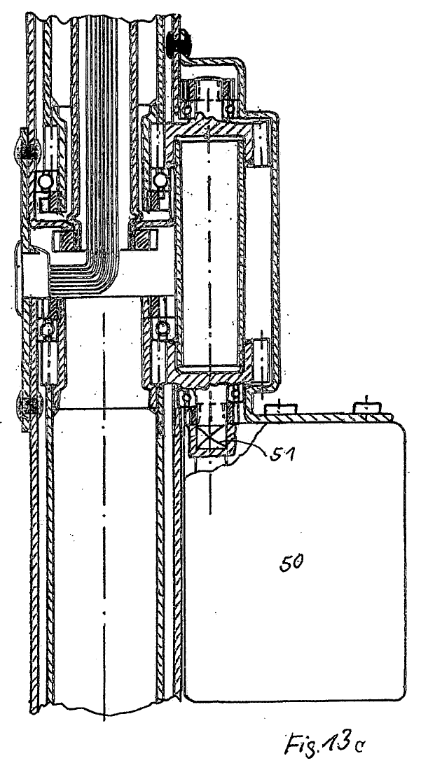

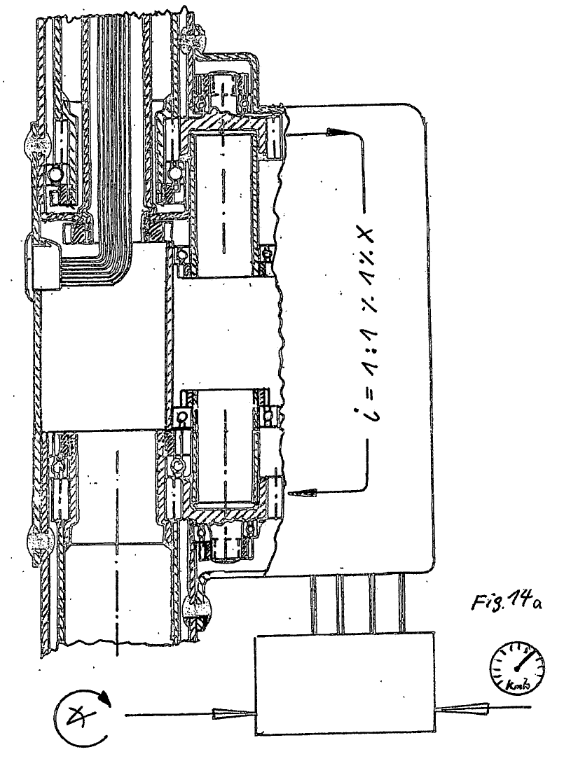

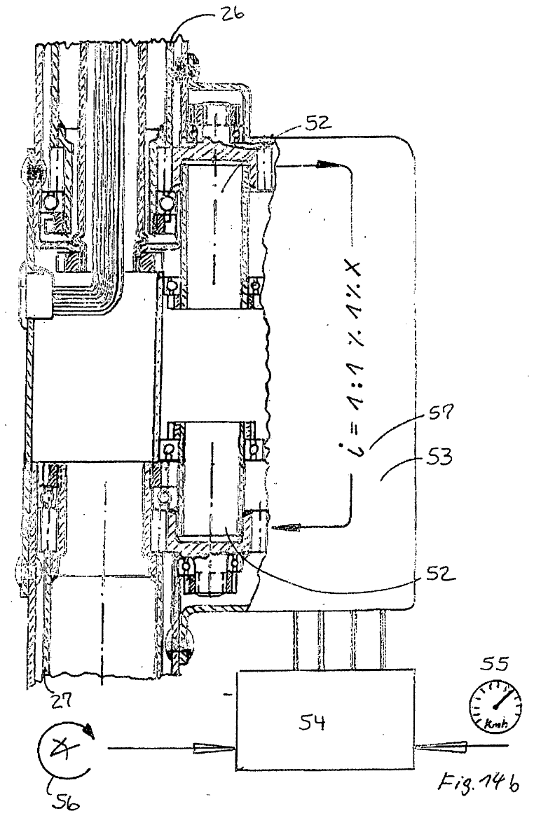

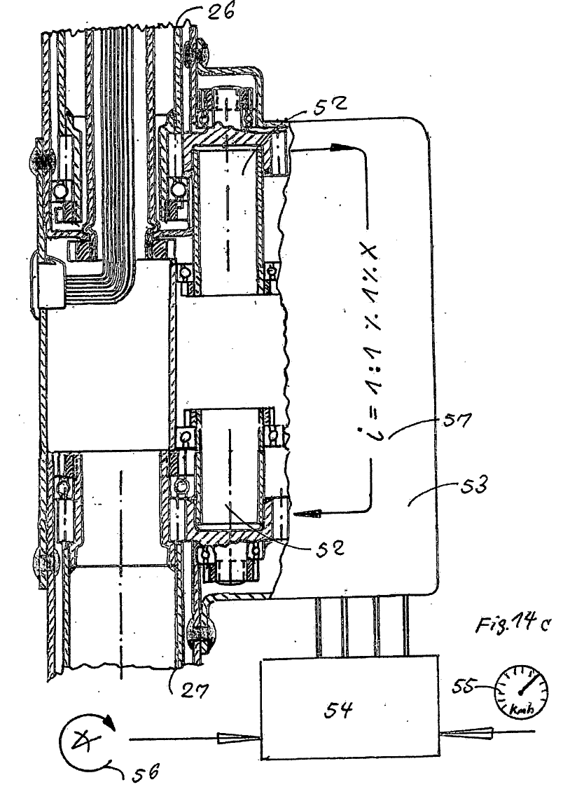

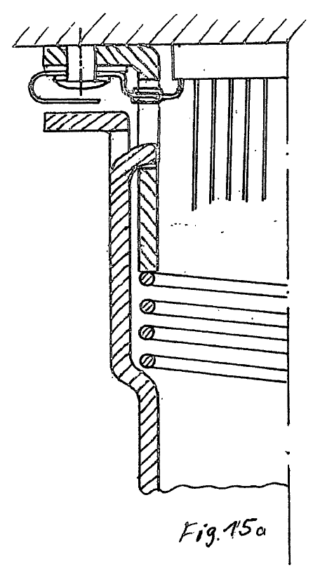

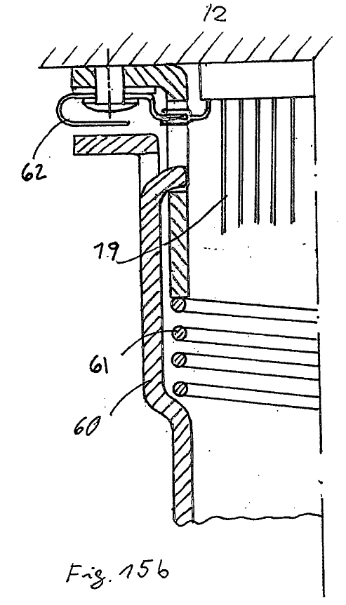

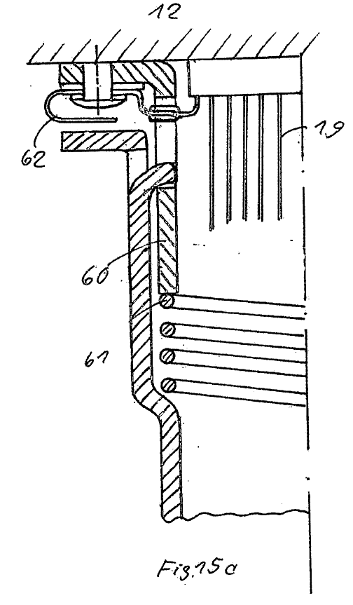

In another embodiment shown in FIGS. 13a, b, c, the variation illustrated in FIGS. 12a, b, c is used for flanging on a servo mechanism/power steering system 50 in the simplest possible fashion because the free shaft end 51 of the gear is more cost-efficient than today's conventional “docking” of the power steering system.

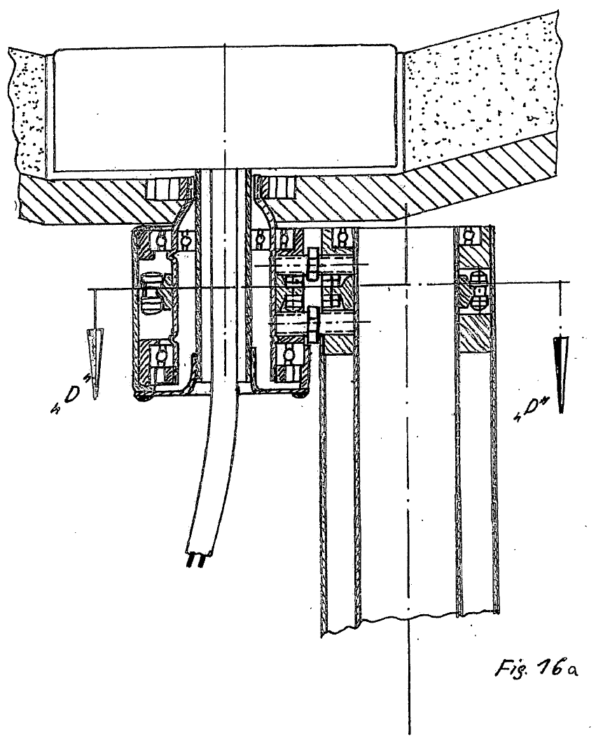

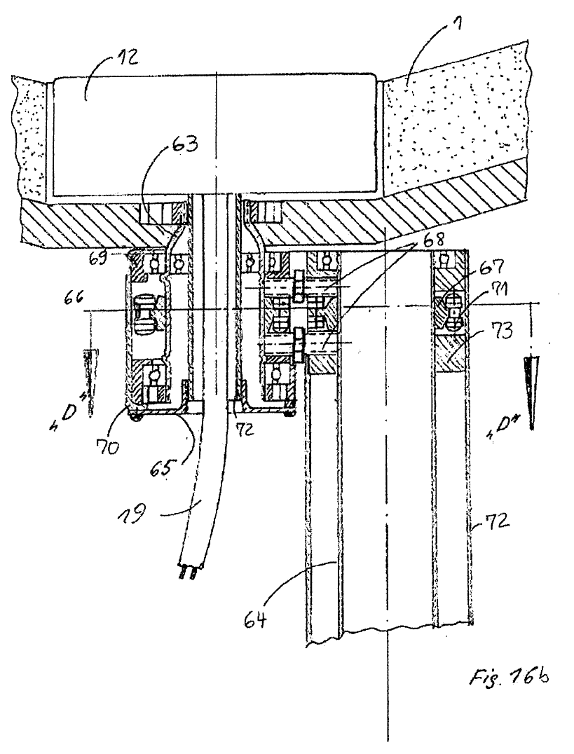

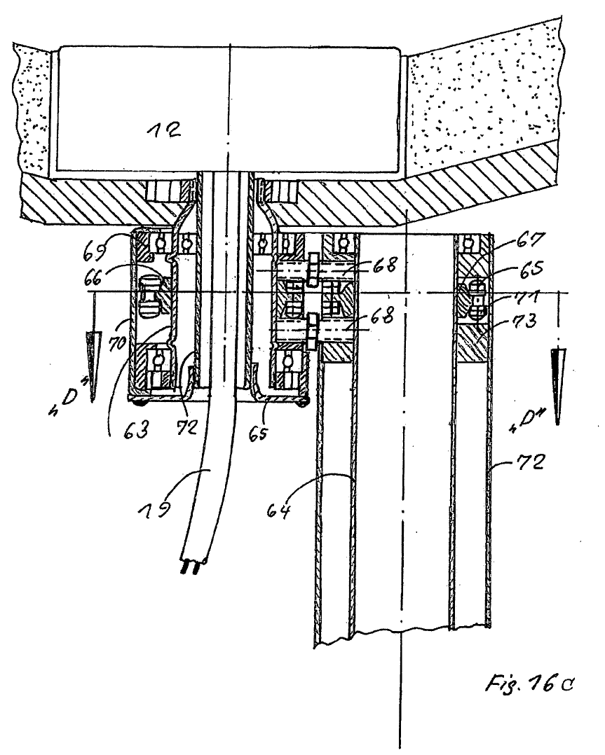

In another embodiment that is shown in FIGS. 14a, b, c, the gear 52 is separated and a device 53 for changing the transmission is arranged in between. A computer 54 records the speed 55 of the automobile and the angle of rotation 56 of the steering wheel and calculates the transmission ratio 57 between the lower and the upper steering column shafts 26, 27 therefrom. The technical design of the device 53 for changing the transmission and its peripheral equipment are not discussed in greater detail because this is already standard equipment, e.g., since 2003 in the so-called 5-series of BMW automobiles. A servo mechanism and a device for changing the transmission may also be combined. The relevant aspect of the invention is the connection of both known steering improvement mechanisms at this location because the steering column shaft is divided anyway in this region due to the “stationary” airbag 12.

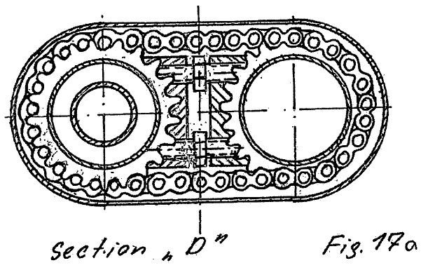

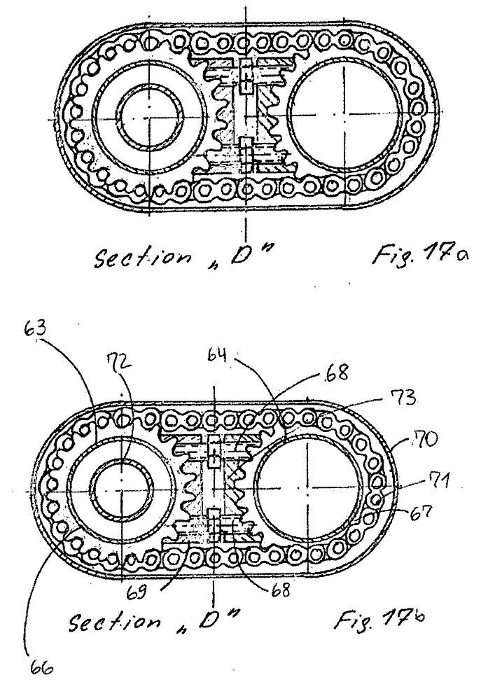

Since the airbag 12 is seated on a tube 23, it is advantageous to arrange the horn actuation 59 in a correspondingly molded tube 58 with the aid of an inserted tube 60 that is telescopically moved against a spring 61 and thusly closes the contacts 62. The telescopic travel can be very easily restricted with conventional technical means as illustrated in the figures. This central unit is exceptionally cost-efficient and above all compact (see also FIGS. 15a, b, c).

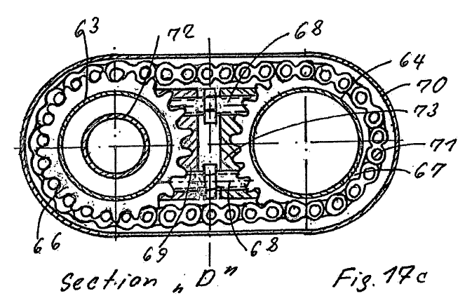

FIGS. 16a, b, c show an alternative in the form of yet another embodiment. The mechanism is divided into a short steering column shaft 63 and a long steering column shaft 64. The steering column shafts 63 and 64 are supported in the first housing (1) 69 and the second housing (2) 73. The steering column shafts 63 and 64 are provided with first and second chain wheels (1) and (2) 66 and 67. These chain wheels are connected to the chain 71. The chain 71 needs to be tensioned such that it has “no play;” in the embodiment shown, this is realized in an exemplary fashion with two setscrews 68. The setscrews connect the two housings 69 and 73, have left-hand and right-hand threads and make it possible to render the chain 71 “free of play” by turning the screws. Other chain tensioning devices can also be utilized. All cables 19 can extend through the continuously open “short” steering column shaft 63. The stationary tube 72 is mounted on a cover 65 that forms part of the first housing (1) 69.

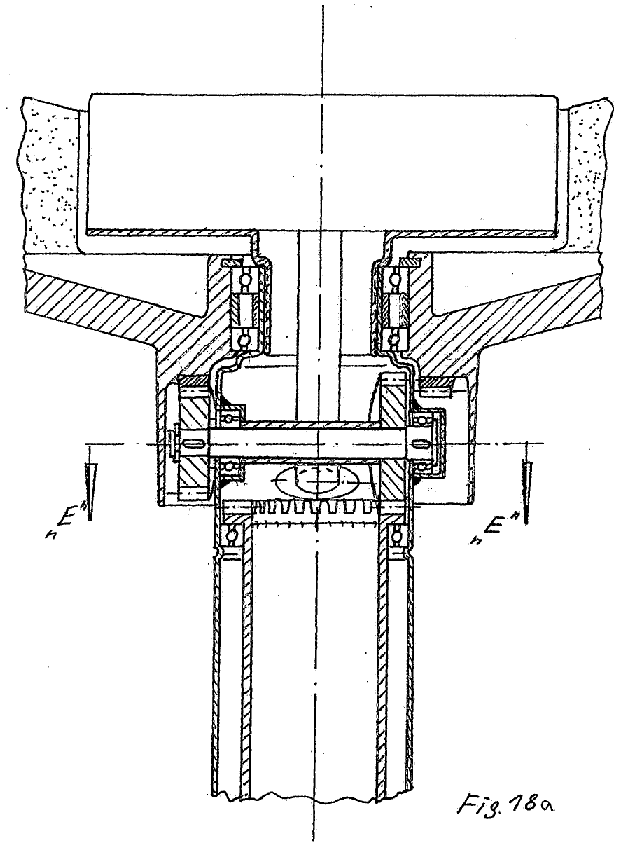

FIGS. 17a, b, c show the arrangement of the short steering column shaft 63, the long steering column shaft 64, the first chain wheel (1) 66, the second chain wheel (2) 67, the setscrews 68, the first housing (1) 69, the sheet metal enclosure 70, the chain 71, the stationary tube 72, the airbag 12 and the second housing (2) 73 in the form of sections D of FIGS. 16a, b, c.

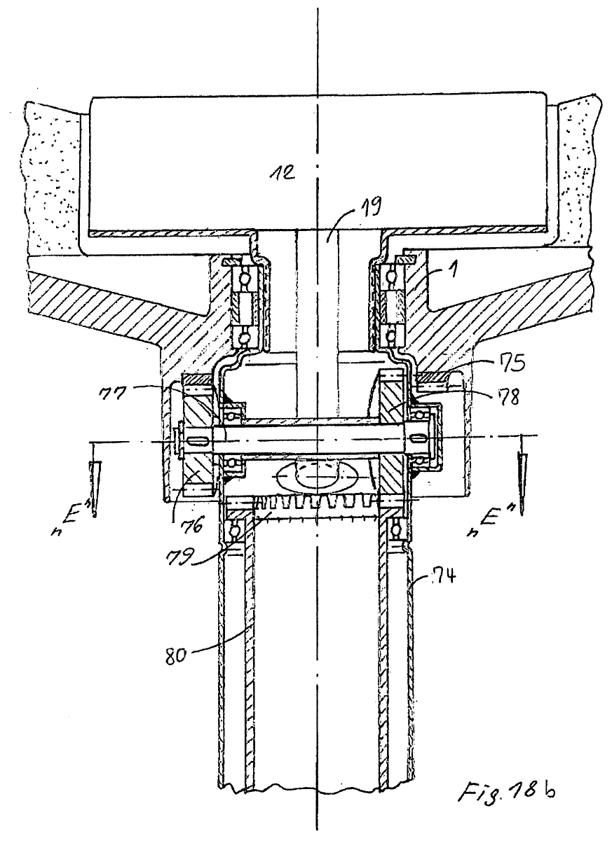

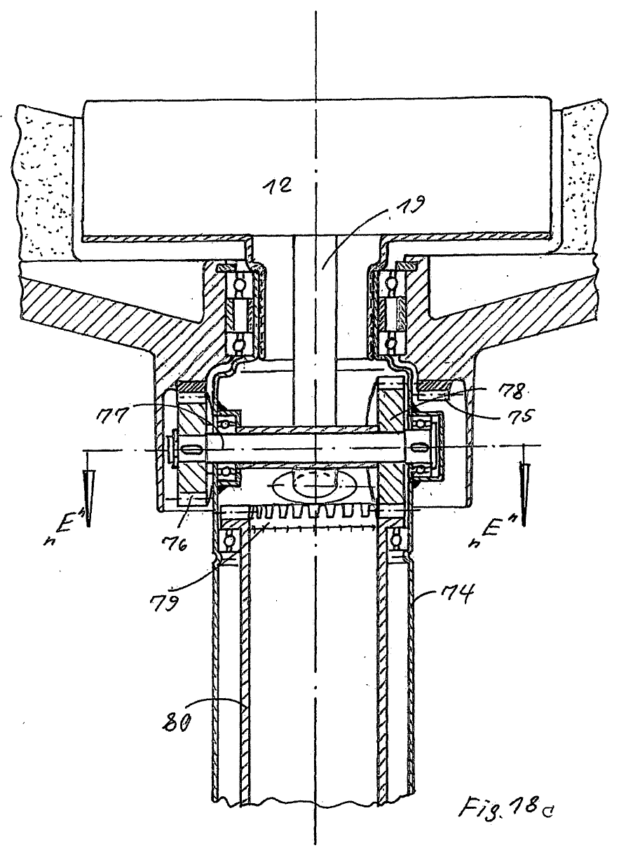

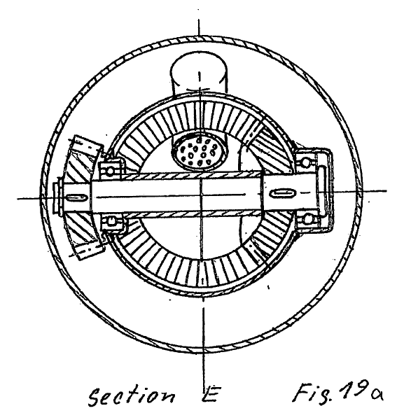

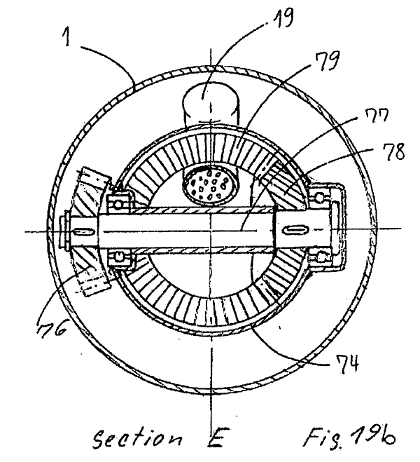

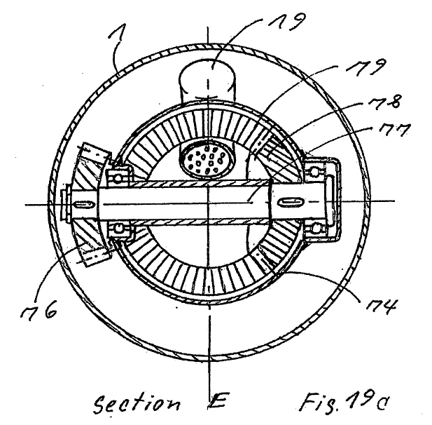

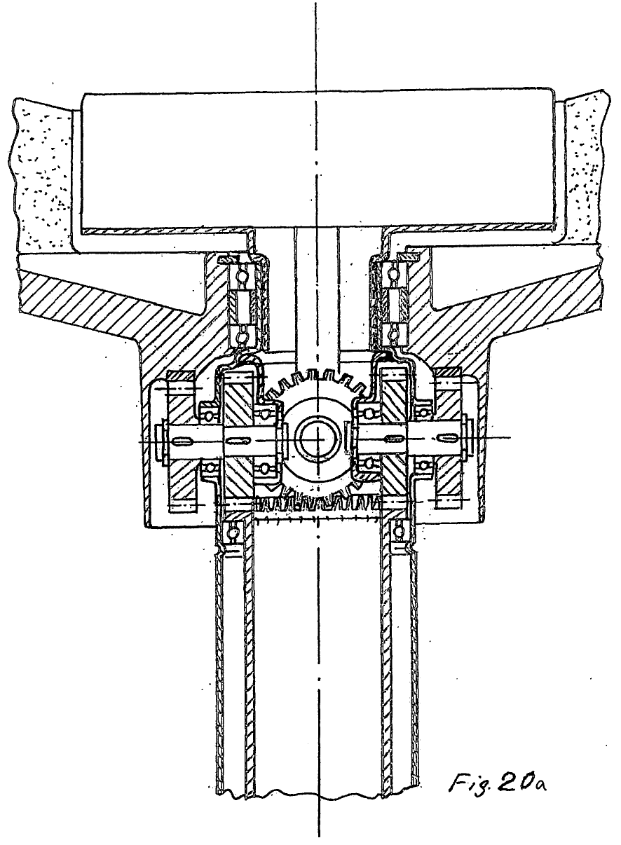

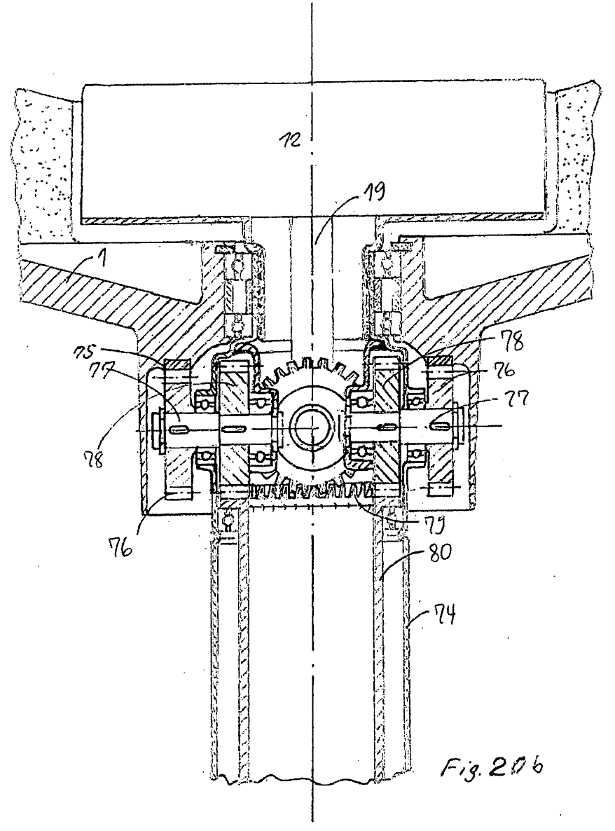

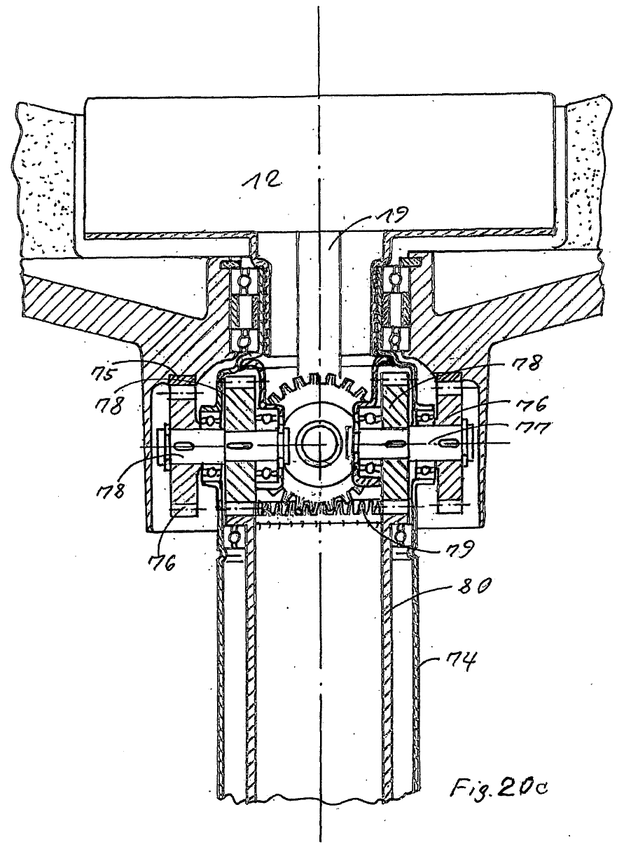

FIGS. 18a, b, c show another particularly simple alternative in the form of yet another embodiment. An outer stationary steering column tube 74 carries the stationary airbag 12 on its upper end. A special steering wheel 1 with a gearing 75 is supported on the end of the stationary steering column tube 74. When the steering wheel 1 is turned, the gearing 75 drives a gearwheel 76 that turns perpendicular to the gearing 75 of the steering wheel 1. The gearwheel 76 embodiments and their illustrations in the figures, and is able to combine these variations, modifications, substitutions and combinations with that person's professional expertise and the state of the art. It is possible, in particular, to combine all individual characteristics and possible designs of the invention as well as the embodiments thereof.

1-47. (canceled)

48. An airbag assembly with a mechanism for a “stationary” driver's airbag, i.e., a driver's airbag that does not rotate with the steering wheel, wherein the mechanism is situated within the steering column, characterized by the fact that it contains a steering shaft that is divided into two sections.

49. The airbag assembly according to claim 48, characterized by the fact that the upper and the lower steering shaft are alternatively arranged adjacent to one another, particularly in accordance with FIG. 1a, b, c or 16a, b, c.

50. The airbag assembly according to claim 49, characterized by the fact that the steering column shafts are realized in such a way that they are supported in a common housing.

51. The airbag assembly according to claim 49, characterized by the fact that the airbag is supported on a “tube” that is open on the bottom, particularly in accordance with FIG. 1a, b, c or 16a, b, c.

52. The airbag assembly according to claim 49, characterized by the fact that the upper and the lower section of the steering wheel shaft are connected by means of a gear.

53. The airbag assembly according to claim 52, characterized by the fact that the connection between the two steering column halves is realized with the aid of gearwheels, particularly in accordance with FIGS. 1a, b, c.

54. The airbag assembly according to claim 52, characterized by the fact that the connection between the two steering column halves is realized with the aid of a chain, particularly in accordance with FIG. 16a, b, c or 17a, b, c.

55. The airbag assembly according to claim 54, characterized by the fact that the housing halves are realized in such a way that they are suitable for accommodating a chain tightener.

56. The airbag assembly according to claim 55, characterized by the fact that tile housing halves are realized in such a way that their position can be varied by means of left-hand/right-hand threads, namely such that the connecting chain has “no play,” particularly in accordance with FIG. 16a, b, c or 17a, b, c.

57. The airbag assembly according to claim 52, characterized by the fact that the steering gear of the steering column mechanism is realized in such a way that the opposite movement of the steering wheel and the steering column is once again compensated, particularly in accordance with FIGS. 5a, b, c.

58. The airbag assembly according to claim 52, characterized by the fact that the connecting gear is realized in such a way that it is homogenously accommodated in the “interior” of the steering shaft or therebetween without requiring additional space.

59. The airbag assembly according to claim 52, characterized by the fact that the gear is realized in such a way that the upper and the lower steering shaft respectively feature a “sun gear” on the outer end.

60. The airbag assembly according to claim 59, characterized by the fact that the gear is realized in such a way that the sun gears are connected by means of planet gears on an axle supported in the stationary gear housing.

61. The airbag assembly according to claim 52, characterized by the fact that the gear is realized in the sun gears and planet gears in such a way that the tube carrying the airbag can be led through therebetween with its cable leadthrough, particularly in accordance with FIGS. 8a, b, c.

62. The airbag assembly according to claim 52, characterized by the fact that the connecting gear is realized in such a way that the upper and the lower steering shaft are provided with bevel gears on their ends, that the two bevel gears are connected to an additional bevel gear that is stationary mounted or supported in the steering column tube, with the steering shafts rotating, in particular, with identical rotational speeds, and wherein the steering shafts preferably rotate in opposite directions and the steering gear is realized accordingly, particularly in accordance with FIGS. 10a, b, c, and that the gear is realized in such a way that an additional bevel gear engages into the bevel gear of the lower steering shaft with a 180 degree offset, particularly in accordance with FIGS. 11a, b, c, and wherein the rotating directions of the upper and the lower steering shaft are preferably identical.

63. The airbag assembly according to claim 52, characterized by the fact that the connecting gear is realized in such a way that the transmission ratio between the upper and the lower steering shaft is adapted in a speed-dependent and/or steering angle-dependent fashion, particularly in accordance with FIGS. 14a, b, c.

64. The airbag assembly according to claim 52, characterized by the fact that the connecting gear is realized with such a transmission between the sun gears and planet gears that the desired deviation between the rotational speeds of the steering wheel and the steering shaft is achieved.

65. The airbag assembly according to claim 48, characterized by the fact that the airbag support tube is realized in such a way that it accommodates another telescope-like tube section supported in springs.

66. The airbag assembly according to claim 65, characterized by the fact that the telescopic tubes are realized in such a way that they serve for accommodating contacts of the horn mechanism in an insulated fashion, particularly in accordance with FIGS. 15a, b, c.

67. The airbag assembly according to claim 48, characterized by the fact that the steering column shaft, particularly in accordance with FIGS. 18a, b, c, is realized in such a way that a “sun gear” is arranged on its upper end.

68. An airbag assembly with a stationary airbag mechanism, characterized by the fact that the stationary steering column tube creates a connection for the stationary airbag on a correspondingly bent tube, particularly in accordance with FIG. 18a, b, c or 19a, b, c.

69. The airbag assembly according to claim 68, characterized by the fact that the stationary steering column tube is realized in such a way that a connecting gear between the steering wheel and the steering shaft is also supported therein, particularly in accordance with FIGS. 18a, b, c.

70. The airbag assembly according to claim 68, characterized by the fact that the stationary steering column tube is realized in such a way that a special steering wheel is rotatably supported thereon, particularly in accordance with FIGS. 18a, b, c.

71. The airbag assembly according to claim 70, characterized by the fact that the special steering wheel is realized in such a way that a sun gear is integrated into or mounted on the lower rotating assembly.
